(19) United States
(12) Patent Application Publication
(10) Pub. No.: US 2016/0098163 A1
(43) Pub. Date: Apr. 7, 2016

(54) METHOD AND APPARATUS FOR DISPLAYING PREVIEWS

(71) Applicant: Samsung Electronics Co., Ltd., Gyeonggi-do (KR)

(72) Inventors: Kyoung-Ae KIM, Seoul (KR); Hee-Jung KIM, Gyeonggi-do (KR); Jung-Hyun KIM, Gyeonggi-do (KR); Ja-Kyoung LEE, Seoul (KR); Sung-Han KIM, Seoul (KR)

(21) Appl. No.: 14/865,338

(22) Filed: Sep. 25, 2015

(30) Foreign Application Priority Data
Oct. 2, 2014 (KR) 10-2014-0133116

(51) Int. Cl. G06F 3/0483; G06F 3/0484; G06F 3/0482

(52) U.S. Cl. CPC G06F 3/0483; G06F 3/0482; G06F 3/04842

(57) ABSTRACT

A method and an apparatus for providing a content preview in a server are provided. An electronic device includes a display; a communication interface configured to send and receive signals to and from a server; and a processor configured to display a preview image of content received from the server on the display, and in response to an input, switch from the displayed preview image to a different preview image of the content or switch from the displayed preview image to a preview image of a different content. Thus, the electronic device may consecutively display the content preview screens without having to switch the screen.

### CLAIM OF PRIORITY

This application claims priority under 35 U.S.C. §119(a) to Korean Patent Application Serial No. 10-2014-0133116, which was filed in the Korean Intellectual Property Office on Oct. 2, 2014, the entire content of which is incorporated herein by reference.

### BACKGROUND

The present disclosure relates generally to a method and an apparatus for providing a content preview in a server.

Based on rapid development of electronic devices such as smart phones and tablet Personal Computers (PCs), wireless voice communication and information exchange have become necessities in life. In an early stage the electronic device merely provided wireless voice communication. Today, the electronic device has evolved to operating as a multimedia service device used for scheduling management tasks, playing games, performing remote control, capturing images, browsing the Internet, and using Social Network Service (SNS), etc.

As a result of recent developments an application store allows users to download desired content to an electronic device. To this end users may search an application store for desired content and download for free, or purchase, the searched content.

Typically, an application store provides a content preview so that users may inspect corresponding content before the purchase. However, in order to see previews of content for the purchase, the user needs to repeatedly and onerously switch an initial screen to a content list screen, then a content detail screen, and then a content preview screen, in that order, just to see a content preview.

Accordingly, there is a need for an improved method for consecutively displaying the content preview screens in a more efficient manner to avoid forcing users to repeatedly switch the screen when previewing content.

### SUMMARY

To address the aforementioned deficiencies of the prior art, the present disclosure provides an improved way for providing a content preview screen in a server.

One aspect of the present disclosure is to provide a method and an apparatus for consecutively displaying preview screens of different content provided from a server, in an electronic device.

Another aspect of the present disclosure is to provide a method and an apparatus for purchasing content using an improved content preview screen according to the teachings of the present disclosure in a server.

According to one aspect of the present disclosure, an electronic device includes a display; a communication interface configured to send and receive signals to and from a server; and a processor configured to display a preview image of content received from the server on the display, and in response to an input, switch from the displayed preview image to a different preview image or switch from the displayed preview image to a preview image of a different content.

According to another aspect of the present disclosure, an operating method of an electronic device includes displaying a preview image of content received from a server on a display; and responsive to an input, for switching from the displayed preview image to a different preview image of the content or switching from the displayed preview image to a preview image of a different content

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other aspects, features, and advantages of certain exemplary embodiments of the present disclosure will be more apparent from the following description taken in conjunction with the accompanying drawings, in which:

FIG. 1 illustrates content preview screens displayed in a row in an electronic device according to an exemplary embodiment of the present disclosure;

FIG. 2 illustrates a server according to an exemplary embodiment of the present disclosure;

FIG. 3 illustrates a network including an electronic device according to an exemplary embodiment of the present disclosure;

FIG. 4 illustrates operations of an electronic device according to an exemplary embodiment of the present disclosure;

FIG. 5 illustrates arrangement of content preview screens according to an exemplary embodiment of the present disclosure;

FIG. 6A, FIG. 6B, FIG. 6C and FIG. 6D illustrate content preview screen switching using an input user gesture in an electronic device according to an exemplary embodiment of the present disclosure;

FIG. 7A and FIG. 7B illustrate content preview screen switching using a content preview screen index in an electronic device according to an exemplary embodiment of the present disclosure;

FIG. 8A and FIG. 8B illustrate content preview screen control of various formats in an electronic device according to an exemplary embodiment of the present disclosure; and

FIG. 9 illustrates an electronic device according to an exemplary embodiment of the present disclosure.

Throughout the drawings, like reference numerals will be understood to refer to like parts, components and structures.

### DETAILED DESCRIPTION

Hereinafter, embodiments of the present disclosure are described in detail with reference to the accompanying drawings. Those of ordinary skill in the art will recognize that various changes and modifications of the embodiments described herein may be made without departing from the scope of the present disclosure. In addition, descriptions of well-known functions and constructions may be omitted for clarity and conciseness. The same reference symbols are used throughout the drawings to refer to the same or like parts.

Expressions such as “include” or “may include” that may be used in the present disclosure indicate existence of a disclosed relevant function, operation, or element, etc., and do not limit additional one or more functions, operations, or elements, etc. Also, it should be understood that terms such as “include” or “have” in the present disclosure are intended for designating the existence of a characteristic, a number, a step, an operation, an element, a part, or a combination thereof described in this disclosure and do not exclude in advance the existence or additional possibility of one or more other characteristics, numbers, steps, operations, elements, parts, or a combination thereof.

An expression such as “or”, etc. in the present disclosure includes a certain and all combinations of words listed together. For example, “A or B” may include A or may include B, or may include both A and B.

In the present disclosure, expressions such as “1^{st},” “2^{nd},” “first,” or “second,” etc. may modify various elements of the present disclosure but do not limit relevant elements. For example, these expressions do not limit sequence and/or importance, etc. of relevant elements. The expressions may be used for distinguishing one element from another element. For example, both a first user apparatus and a second user apparatus are all user apparatuses, and represent different user apparatuses. For example, a first element may be referred to as a second element, and similarly, the second element may be referred to as the first element.

When it is mentioned that a certain element is “connected to” or “accesses” another element, it should be understood that the element may be directly connected to another element or may directly access another element, but still another element may exist in the middle. In contrast, when it is mentioned that a certain element is “directly connected to” or “directly accesses” another element, it should be understood that still another element does not exist in the middle.

Terminology used in the present disclosure is used for explaining a specific embodiment and is not intended for limiting the present disclosure. Unless clearly expressed otherwise, expression of the singular includes expression of the plural.

Unless defined differently, all terminologies used herein including technological or scientific terminologies have the same meaning as that generally understood by a person of ordinary skill in the art to which the present disclosure belongs. It should be understood that generally used terminologies defined by a dictionary have meanings consistent with meanings of a related technology, and unless clearly defined in the present disclosure, they are not understood as an ideal or excessively formal meaning.

The term “module” as used herein may be defined as, for example, a unit including a combination of one or two or more among a hardware, a software, or a firmware. The term “module” may be interchangeably used with the phrase unit, logic, a logical block, a component, or a circuit, etc. A “module” may be a minimum unit of an integrally configured part or a portion thereof. A “module” may be a minimum unit performing one or more functions or a portion thereof. A “module” may be mechanically or electronically implemented. For example, a “module” according to the present disclosure may include one or more of an Application-Specific Integrated Circuit (ASIC) chip, a Field-Programmable Gate Arrays (FPGAs), or a programmable-logic device which are known, or to be developed in the future, and performing certain operations.

An electronic device according to the present disclosure may be a device including a communication function. For example, an electronic device may include one or more of, but is not limited to, a smartphone, a tablet personal computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, or a wearable device (e.g., a head-mounted-device (HMD) such as electronic glasses, an electronic clothing, an electronic bracelet, an electronic necklace, an electronic appcessory, an electronic tattoo, or a smartwatch).

The electronic device may be a smart home appliance having a communication function. A smart home appliance may include, but is not limited to, one or more of a television, a Digital Video Disk (DVD) player, an audio, a refrigerator, an air conditioner, a cleaner, an oven, an electronic range, a washing machine, an air purifier, a set-top box, a TV box (e.g., Samsung HomeSync®, Apple TV®, or Google TV®), game consoles, an electronic dictionary, an electronic key, a camcorder, or an electronic frame.

The electronic device may include, but is not limited to, one or more of various medical devices (e.g., Magnetic Resonance Angiography (MRA), Magnetic Resonance Imaging (MRI), Computed Tomography (CT), a shooting device, an ultrasonic device, etc.), a navigation device, a Global Positioning System (GPS) receiver, an event data recorder (EDR), a flight data recorder (FDR), an automobile infotainment device, electronic equipment for a ship (e.g., a navigation device for a ship, a gyro compass, etc.), avionics, a security device, or a robot for an industrial use or a home use.

The electronic device may include, but is not limited to, one or more or more of furniture or a portion of a building/structure including a communication function, an electronic board, an electronic signature receiving device, a projector, or various measurement devices (e.g., waterworks, electricity, gas, or radio wave measuring device, etc.). The electronic device may be a combination of one or more of the above-described devices. Also, the electronic device is not limited to the above-described devices.

Hereinafter, an electronic device is described with reference to the accompanying drawings. A user as described herein may indicate a person who uses an electronic device or a device (e.g., an artificial intelligence electronic device) that uses the electronic device.

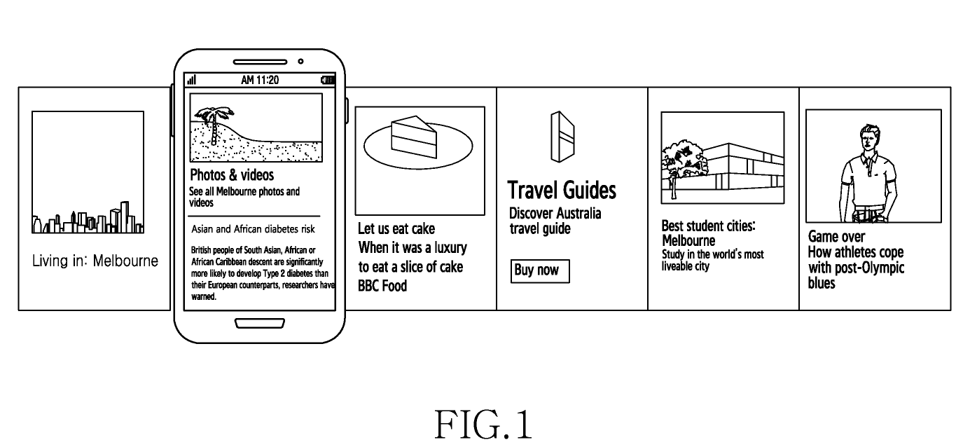

FIG. 1 depicts content preview screens displayed in a row in an electronic device according to an exemplary embodiment of the present disclosure.

Referring to FIG. 1, when a user of an electronic device begins to execute the operations of an application store, the electronic device may provide a content preview for checking content in the application store, for purchase. When the user compares different content for the content purchase, the electronic device may consecutively display preview images of the different content under user control so as to provide a screen configured to display the preview images of different content through fewer screen switches. For example, when receiving a screen switch input while displaying the last preview image of content A, the electronic device may then provide a preview image of content B.

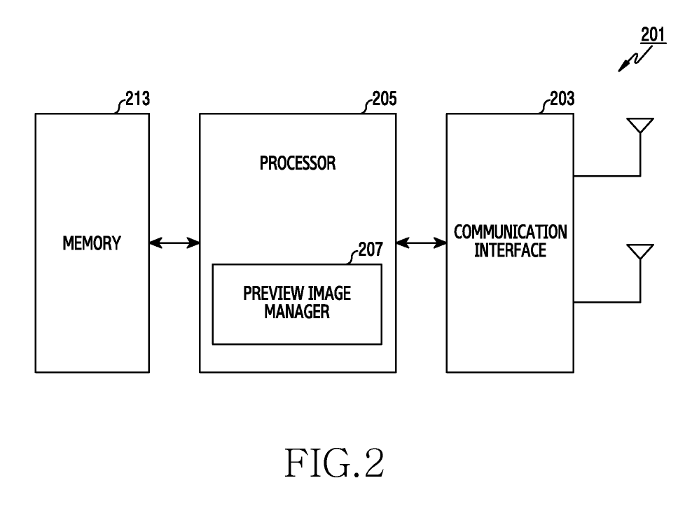

FIG. 2 is a block diagram of a server according to an exemplary embodiment of the present disclosure.

Referring to FIG. 2, the server 201 may include a communication interface 203, a processor 205, and a memory 213. Hereafter, the server 201 may include an application store server for storing and managing one or more content and providing one or more content according to a request of the electronic device. The content may include any content downloaded or purchased from the server in the electronic device. For example, the content may include a video, an application, an e-book, an image, a game, music, an icon, a font, a sticker, an emoticon, and so on.

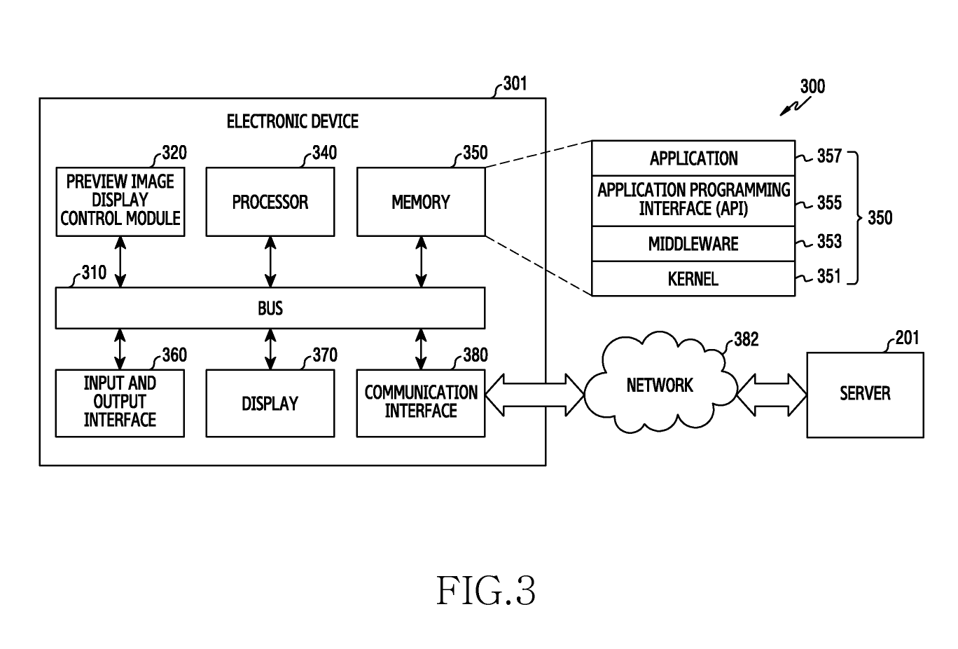

The communication interface 203 may establish communication between the server 201 and an external device (e.g., an electronic device 301 of FIG. 3). For example, the communication interface 203 may wirelessly communicate with the electronic device 301 over a network. The wireless communication may include one or more of, for example, Wireless Fidelity (WiFi), Bluetooth (BT), Bluetooth Low Energy (BLE), Near Field Communication (NFC), satellite communication (e.g., Global Positioning System (GPS)), and cellular communication (e.g., Long Term Evolution (LTE), LTE-Advanced (LTE-A), Code Division Multiple Access (CDMA), Wideband Code Division Multiple Access (WCDMA), Universal Mobile Telecommunications System (UMTS), Wireless Broadband (WiBro), or Global System for Mobile Communications (GSM)).

The communication interface 203 may provide the preview image per content to one or more electronic device connected or accessed to the server 201. The communication interface 203 may receive a content purchase request from the one or more electronic device connected or accessed, and send content corresponding to the received content purchase request to the corresponding electronic device.

The processor 205 may process and control operations of the server 201. In particular, the processor 205 may include a preview image manager 207.

The preview image manager 207 may consecutively store and manage preview images of content registered in the server 201, per content. The preview image manager 207 may consecutively store and manage preview images of one content, and link the last preview image of the one content with a first preview image of different content. For example, when the content A include three preview images, the preview image manager 207 may store and manage the content preview images as a first preview image, a second preview image, and a third preview image in order. For example, when the content A include three preview images and content B include two preview images, the preview image manager 207 may store and manage the content preview images by sequentially linking the first preview image of the content A, the second preview image of the content A, the third preview image of the content A, the first preview image of the content B, and the second preview image of the content B.

The preview image manager 207 may provide the content preview image to the electronic device 301 according to a content preview request received from the electronic device 301. For example, when receiving the preview request of the content A from the electronic device 301, the preview image manager 207 may provide the content preview image of the content A to the electronic device 301. For example, when receiving the preview request of the content A from the electronic device 301, the preview image manager 207 may provide the electronic device 301 with the preview image of the content A and the linked preview images of different content. Herein, the different content may include content in the same list as the content A, content of the same type as the content A, content of the same attribute as the content A, and content in the same group as the content A.

According to the content purchase request received from the electronic device 301, the preview image manager 207 may provide the requested content to the electronic device 301. For example, when receiving a purchase request for the content A from the electronic device 301, the preview image manager 207 may provide the content A to the electronic device 301.

The memory 213 may store commands or data received from or generated by the processor 205 and the communication interface 203. Although not depicted, the memory 207 may include programming modules of a kernel, a middleware, an application programming interface, and an application. The programming modules may include software, firmware, hardware, or a combination of at least two of them. The memory 207 may store content and one or more preview image of the content.

FIG. 3 depicts a network including an electronic device according to an exemplary embodiment of the present disclosure.

Referring to FIG. 3, the electronic device 301 may include a bus 310, a preview image display control module 320, a processor 340, a memory 350, an input/output interface 360, a display 370, and a communication interface 380.

The bus 310 may interlink the components 320 through 380 of the electronic device 310 and control communications (e.g., control messages) between the components of the electronic device 301.

The preview image display control module 320 may display a preview image of content registered in the server 201, on a screen. More specifically, when receiving an input for displaying a preview image of particular content registered in the server 201 under the user control, the preview image display control module 320 may receive the preview image of the corresponding content from the server 201 and display the received preview image on the screen. The content may include one or more content preview images. For example, when receiving an input for displaying the preview image of the content A on the screen displaying detailed information of the content A, the preview image display control module 320 may display the preview image of the content A on the screen. For example, when a separate content preview image display menu is selected in an application store initial screen, the preview image display control module 320 may display a preview image of arbitrary content on the screen.

Further, when receiving an input for switching the preview image, the preview image display control module 320 may determine whether to switch to another preview image of the same content as the content corresponding to the current preview image or to a preview image of content different from the content corresponding to the current preview image, according to the order of the preview images of the current content displayed on the screen. For example, when the second preview image of the four preview images of the content A is displayed and the input for switching to a next preview image is received, the preview image display control module 320 may switch or update the second preview image of the content A to the third preview image of the content A. For example, when the fourth preview image of the four preview images of the content A is displayed and the input for switching to a next preview image is received, the preview image display control module 320 may switch or update the fourth preview image of the content A to the first preview image of the content B. For example, when the third preview image of the five preview images of the content B is displayed and the input for switching to a previous preview image is received, the preview image display control module 320 may switch or update the third preview image of the content B to the second preview image of the content B. For example, when the first preview image of the five preview images of the content B is displayed and the input for switching to the previous preview image is received, the preview image display control module 320 may switch or update the first preview image of the content B to the last preview image of the content A. When receiving an input for displaying the preview image of the content B while the preview image of the content A is displayed, the preview image display control module 320 may skip the switch from the screen displaying detail information of the content A to the screen displaying detail information of the content B, and control to display the preview image of the content B while the preview image of the content A is displayed.

The preview image display control module 320 may display a content preview index in part of the screen displaying the content preview image, and switch the content preview image according to the selected index. The preview index may include a thumbnail image of the preview image. For example, when thumbnail images of preview images are displayed below the screen displaying the content preview image and a particular thumbnail image is selected, the preview image display control module 320 may switch from the current preview image screen to a content preview image screen corresponding to the selected thumbnail image.

The preview image display control module 320 may provide a purchase menu for purchasing the content corresponding to the preview image in the preview image screen. Hence, the user of the electronic device 301 may close the preview image screen, enter a content detail screen for the purchase, and easily purchase his/her desired content in the content preview image screen without having to select a separate purchase menu.

The processor 340 may receive an instruction from the other components (e.g., the preview image display control module 320, the memory 350, the input/output interface 360, the display 370, and the communication interface 380) of the electronic device 301 via the bus 310, interpret the received instruction, and perform an operation or process data according to the interpreted instruction.

The memory 350 may store the instruction or the data received from or generated by the processor 340 or the other components (e.g., the preview image display control module 320, the memory 350, the input/output interface 360, the display 370, and the communication interface 380). For example, the memory 350 may include programming modules of a kernel 351, a middleware 353, an Application Programming Interface (API) 355, and an application 357. The programming module may be implemented using software, firmware, and hardware, or a combination of at least two of them.

The input/output interface 360 may forward an instruction or data input from the user through an input device (e.g., a sensor, a keyboard, or a touch screen) to, for example, one or more of the preview image display control module 320, the processor 340, the memory 350, and the communication interface 380 via the bus 310. For example, the input/output interface 360 may forward data of the user's touch input through the touch screen, to the processor 340.

The display 370 may display various information (e.g., multimedia data or text data) to the user. For example, the display 370 may display the command or the data fed from the preview image display control module 320, the processor 340, the memory 350, and the communication interface 380 via the bus 310.

The communication interface 380 may establish the communication between the electronic device 301 and the external device (e.g., the server 201). For example, the communication interface 380 may wirelessly communicate with the server 201 over a network 382. The wireless communication may include one or more of, for example, WiFi, BT, BLE, NFC, the satellite communication (e.g., GPS), and the cellular communication (e.g., LTE, LTE-A, CDMA, WCDMA, UMTS, WiBro, or GSM).

A protocol (e.g., transport layer protocol, data link layer protocol, or physical layer protocol) for the communication between the electronic device 301 and the server 201 may be supported by one or more of the application, the API, the middleware, and the kernel of the memory 350 and the communication interface 380.

An electronic device may include a communication interface for sending and receiving signals to and from a server, and a processor for displaying a preview image of content, receiving an input, and switching display of a displayed preview image to another preview image in response to said input, or switching display of a displayed preview image to a preview image having different content.

When the received input is to switch from a currently displayed preview image to a previous preview image, the processor may determine whether the displayed preview image is a first preview image of preview images of the content, and when the displayed preview image is the first preview image of the preview images of the content, the processor may switch and display from the displayed preview image to a last preview image of previous content.

When the displayed preview image is not the first preview image of the preview images of the content, the processor may, in response to an input, switch and display from the displayed preview image to the previous preview image of content.

When the received input is to switch from the displayed preview image to a next preview image, the processor may determine whether the displayed preview image is a last preview image of preview images of the content, and when the displayed preview image is the last preview image of the preview images of the content, the processor may switch and display from the displayed preview image to a first preview image of next content.

When the displayed preview image is not the last preview image of the preview images of the content, the processor may, in response to an input, switch and display from the displayed preview image to the next preview image of the content.

When the preview image of the content is displayed and a purchase menu displayed in part of a screen displaying the preview image is selected, the processor may display a content purchase screen.

The processor may display a preview image index in part of a screen displaying the preview image of the content, and the index may include a thumbnail image of a preview image.

The processor may receive an input for the index and, according to the received input, switch and display from the displayed preview image to a preview image corresponding to the index.

The preview image may include an interaction publication controlled by a received input.

Before displaying content detail information on a screen, when a separate content preview image display menu is selected, the processor may display a preview image.

According to various embodiments, an electronic device may include a display, a communication interface configured to send and receive signals to and from a server, and a processor configured to display a preview image of content received from the server on the display, and in response to an input, switch from the displayed preview image to a different preview image of the content or switch from the displayed preview image to a preview image of the content.

According to various embodiments, the processor may determine whether the displayed preview image is a first preview image of preview images of the content when the received input is to switch from the displayed preview image to a previous preview image, and, the processor may switch from the displayed preview image to a last preview image of previous content when the displayed preview image is the first preview image of the preview images of the content.

According to various embodiments, the processor may switch from the displayed preview image to the previous preview image of the content when the displayed preview image is not the first preview image of the preview images of the content.

According to various embodiments the processor may determine whether the displayed preview image is a last preview image of preview images of the content when the received input is to switch from the displayed preview image to a next preview image, and the processor may switch from the displayed preview image to a first preview image of next content when the displayed preview image is the last preview image of the preview images of the content.

According to various embodiments, the processor may switch from the displayed preview image to the next preview image of the content when the displayed preview image is not the last preview image of the preview images of the content.

According to various embodiments, the processor may display a content purchase menu when the preview image of the content is displayed.

According to various embodiments, the processor may display a preview image index in part of a screen displaying the preview image of the content, and the preview image index may comprise a thumbnail image of a preview image.

According to various embodiments, the processor may receive an input for the index and, according to the received input, switch from the displayed preview image to a preview image corresponding to the index.

According to various embodiments, the preview image may comprise an interactive publication controlled by a received input.

According to various embodiments, the processor may display a preview image before displaying content detail information on a screen, when a separate content preview image display menu is selected.

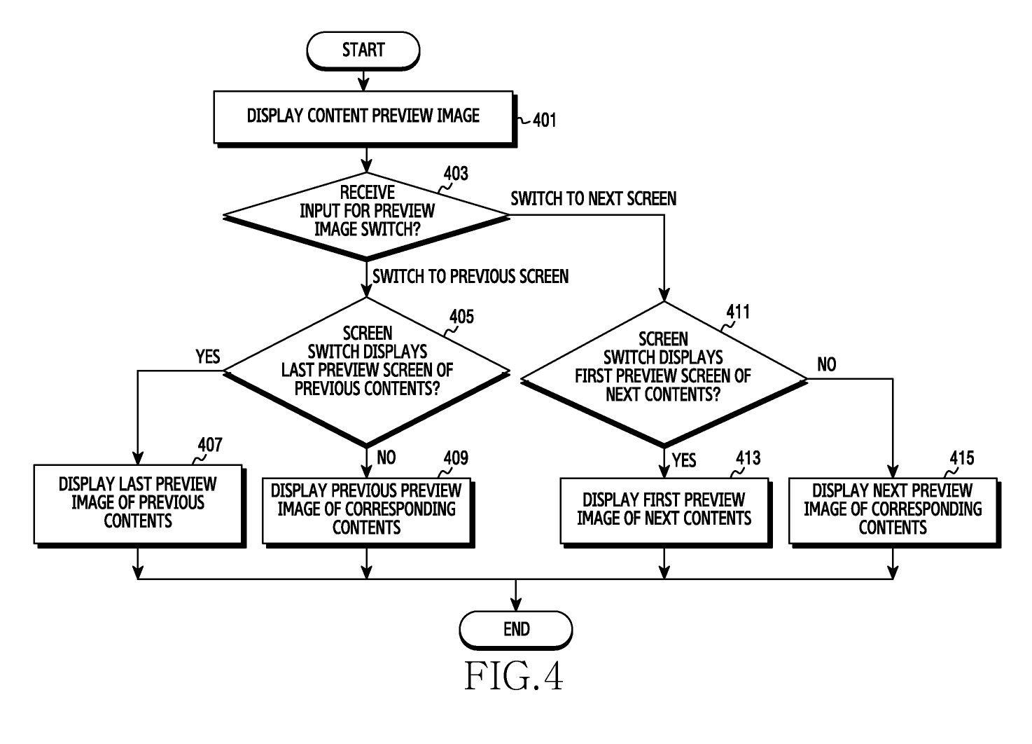

FIG. 4 illustrates operations of an electronic device according to an exemplary embodiment of the present disclosure.

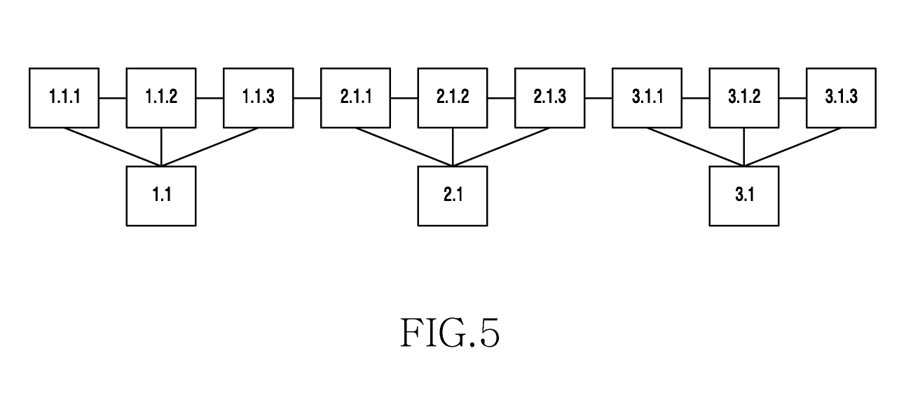

Referring to FIG. 4, the electronic device 301 may display the content preview image on the screen in operation 401. For example, when receiving the input for displaying the preview image of the content A in the detail view screen which displays detailed information of the content A, the electronic device 301 may display the preview image of the content A on the screen. For example, when a separate content preview image display menu is selected in the application store initial screen (e.g., a start screen), the electronic device 301 may display a preview image of arbitrary content on the screen. The content preview image may be managed as shown in FIG. 5. In detail, preview images of content 1.1 may be managed in order of 1.1.1, 1.1.2, and 1.1.3, and the last preview image of the content 1.1 may be managed in connection with a first preview image 2.1.1 of content 2.1. Preview images of the content 2.1 may be managed in order of 2.1.1, 2.1.2, and 2.1.3, and the last preview image of the content 2.1 may be managed in connection with a first preview image 3.1.1 of content 3.1. Preview images of the content 3.1 may be managed in order of 3.1.1, 3.1.2, and 3.1.3.

In operation 403, the electronic device 301 may determine whether the received input is to switch the current preview screen to a previous screen or to a next screen.

When the received input is to switch the current preview screen to the previous screen, the electronic device 301 may determine whether the screen switch is to display a last preview image of previous content in operation 405.

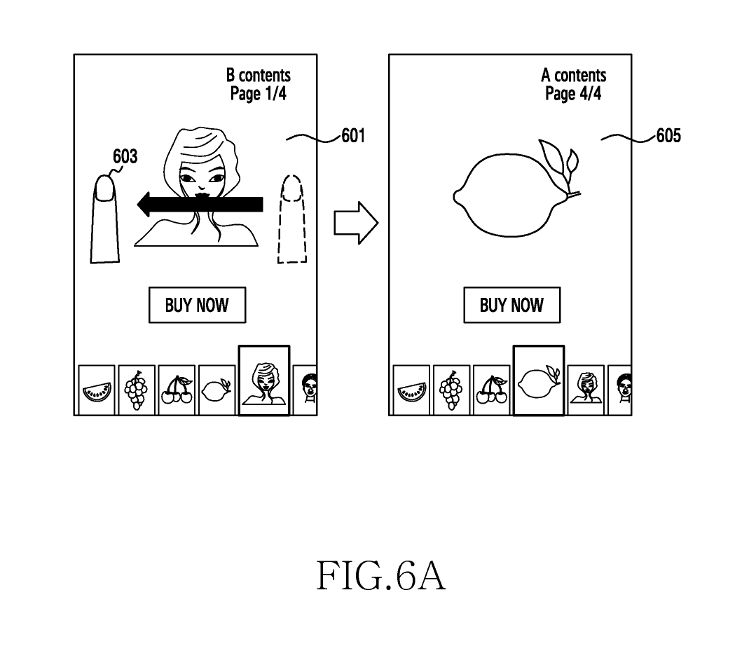

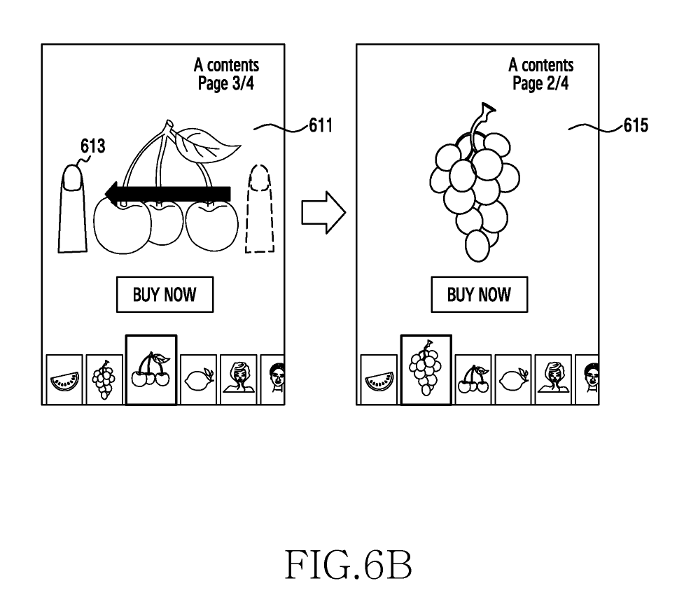

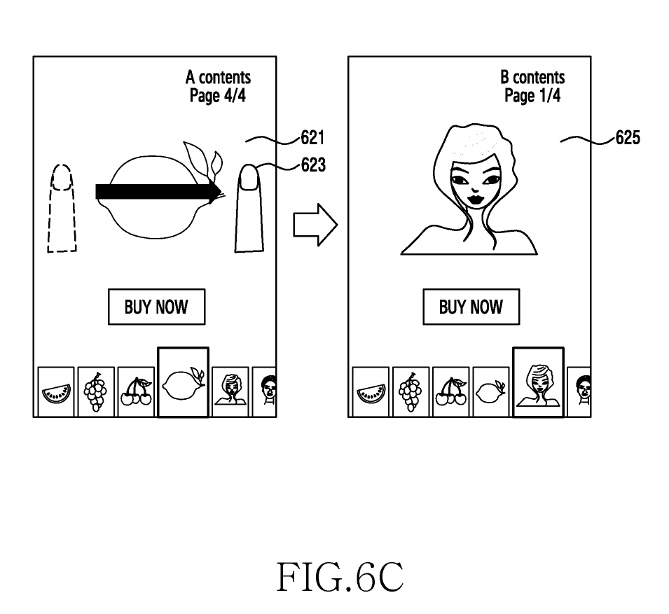

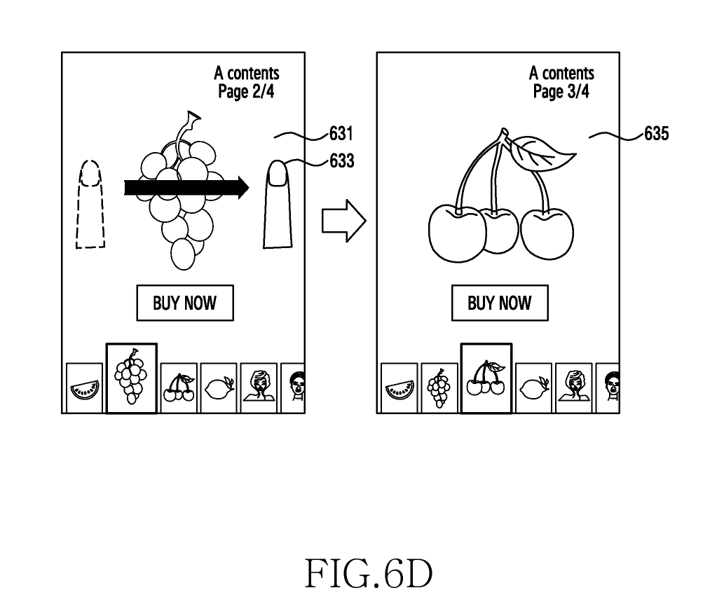

When the screen switch is to display the last preview image of the previous content, the electronic device 301 may display the last preview image of the previous content on the screen in operation 407. For example, as shown in FIG. 6A, when a first preview image 601 of content B is displayed and dragging 603 for switching to a previous screen is detected, the electronic device 301 may switch from the first preview image 601 of the content B to a last preview image 605 of content A.

By contrast, when the screen switch does not display the last preview image of the previous content, the electronic device 301 may display a previous preview image of corresponding content on the screen in operation 409. For example, as shown in FIG. 6B, when a third preview image 611 of four preview images of content A is displayed and dragging 613 for switching to a previous screen is detected, the electronic device 301 may switch from the third preview image 611 of the content A to a second preview image 615 of content A.

When the received input is to switch the current preview screen to the next screen in operation 403, the electronic device 301 may determine the screen switch is to display a first preview image of next content in operation 411.

When the screen switch is to display the first preview image of the next content, the electronic device 301 may display the first preview image of the next content on the screen in operation 413. For example, as shown in FIG. 6C, when a fourth preview image 621 of content A is displayed and dragging 623 for switching to a next screen is detected, the electronic device 301 may switch from the fourth preview image 621 of the content A to a first preview image 625 of content B.

By contrast, when the screen switch is not to display the first preview image of the next content, the electronic device 301 may display a next preview image of corresponding content on the screen in operation 415. For example, as shown in FIG. 6D, when a second preview image 631 of four preview images of content A is displayed and dragging 633 for switching to a next screen is detected, the electronic device 301 may switch from the second preview image 631 of the content A to a third preview image 635 of content A.

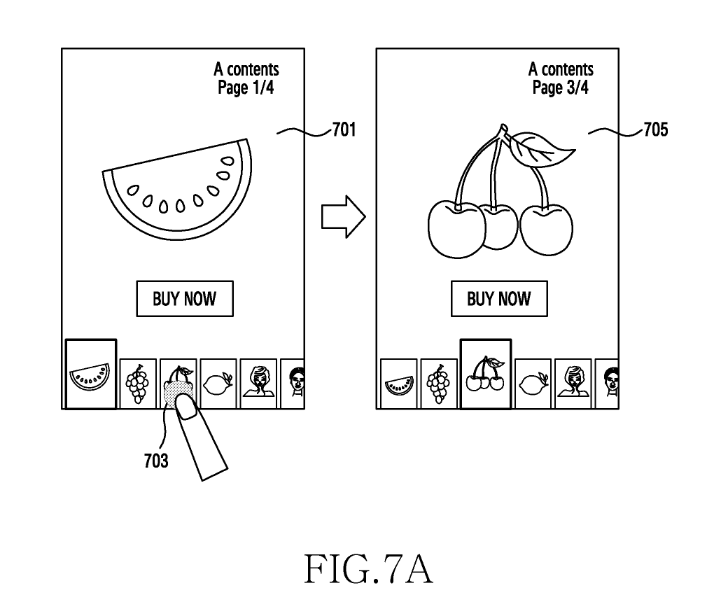

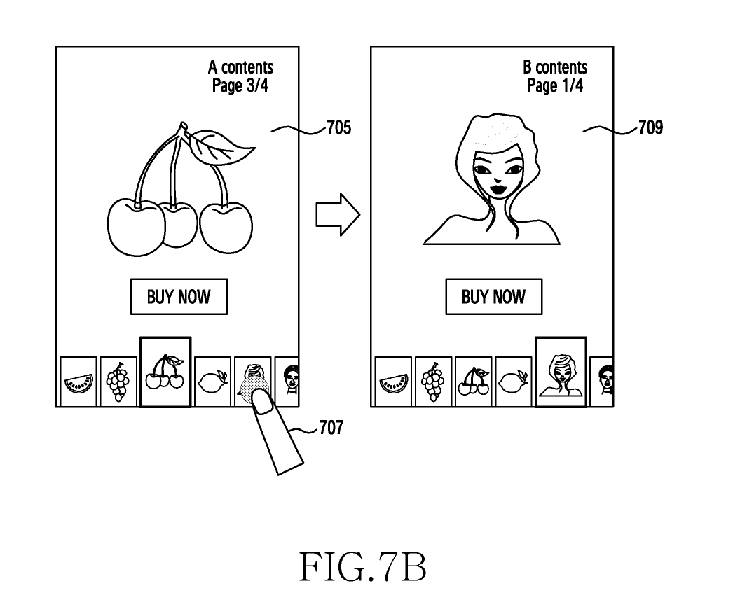

The electronic device 301 may switch and display the preview screen according to the input to the content preview index displayed in part of the screen displaying the preview image. For example, as shown in FIG. 7A, when a first preview image 701 of content A is displayed and touch 703 for a thumbnail image of a third preview image of the content A is inputted, the electronic device 301 may switch from the first preview image 701 of the content A to the third preview image 705 of the content A. For example, as shown in FIG. 7B, when a third preview image 705 of content A is displayed and touch 707 for a thumbnail image of a first preview image of content B is inputted, the electronic device 301 may switch from the third preview image 705 of the content A to the first preview image 709 of the content B.

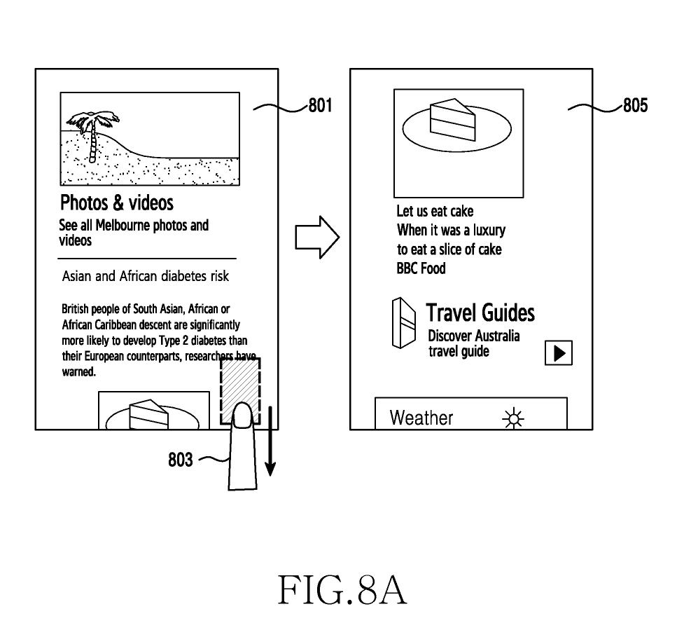

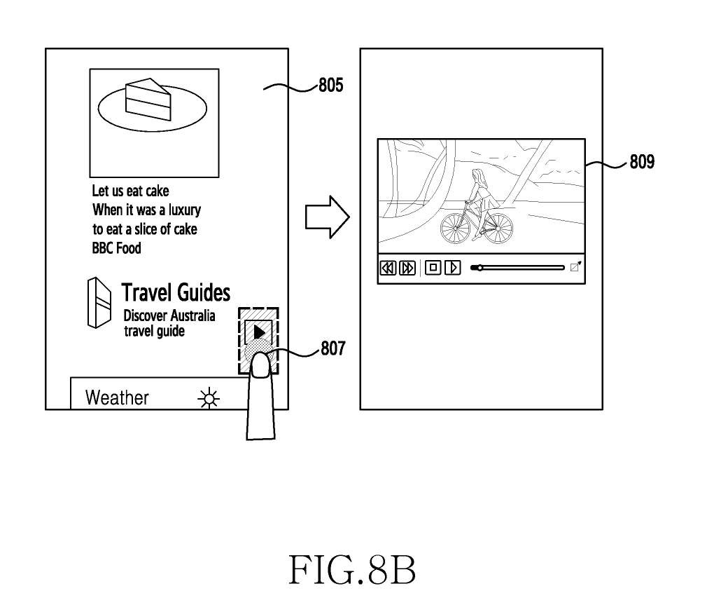

The electronic device 301 may support various preview screens such as interaction publication. For example, when a preview screen 801 displays an image supporting scrolling, the electronic device 301 may update and display the screen 805 according to the scrolling 803 detected on the displayed preview screen 801 as shown in FIG. 8A. For example, when a preview screen 805 displays an image supporting video playback and touch 807 on a video playback menu in the displayed preview screen 805 is detected, the electronic device 301 may display a preset video playback screen 809 as shown in FIG. 8B.

According to various exemplary embodiments, an operating method of an electronic device may include displaying a preview image of content received from a server on a display, and responsive to an input, switching from the displayed preview image to a different preview image of the content or switching from the displayed preview image to a preview image of a different content.

According to various exemplary embodiments, the switching from the displayed preview image to the different preview image of the content or to the preview image of the different content may comprise determining whether the displayed preview image is a first preview image of preview images of the content when the received input is to switch from the displayed preview image to a previous preview image, and switching from the displayed preview image to a last preview image of previous content when the displayed preview image is the first preview image of the preview images of the content.

According to various exemplary embodiments, the operating method may further include switching from the displayed preview image to the previous preview image of the content when the displayed preview image is not the first preview image of the preview images of the content.

According to various exemplary embodiments, the switching from the displayed preview image to the different preview image of the content or to the preview image of the different content may comprise determining whether the displayed preview image is a last preview image of preview images of the content when the received input is to switch from the displayed preview image to a next preview image, and switching from the displayed preview image to a first preview image of next content when the displayed preview image is the last preview image of the preview images of the content.

According to various exemplary embodiments, the operating method may further include switching from the displayed preview image to the next preview image of the content when the displayed preview image is not the last preview image of the preview images of the content.

According to various exemplary embodiments, the operating method may further include displaying a content purchase menu when the preview image of the content is displayed.

According to various exemplary embodiments, the operating method may further include displaying a preview image index in part of a screen displaying the preview image of the content wherein the index comprises a thumbnail image of a preview image.

According to various exemplary embodiments, the operating method may further include receiving an input for the index, and, switching, according to the received input, from the displayed preview image to a preview image corresponding to the index.

According to various exemplary embodiments, the preview image may include an interaction publication controlled by a received input.

According to various exemplary embodiments, the operating method may further include displaying a preview image before displaying content detail information on a screen when a separate content preview image display menu is selected.

A computer-readable storage medium may store one or more programs which execute displaying a preview image of content received from a server on a display, and in response to an input, switching from the displayed preview image to a different preview image of the content or to a preview image of a different content.

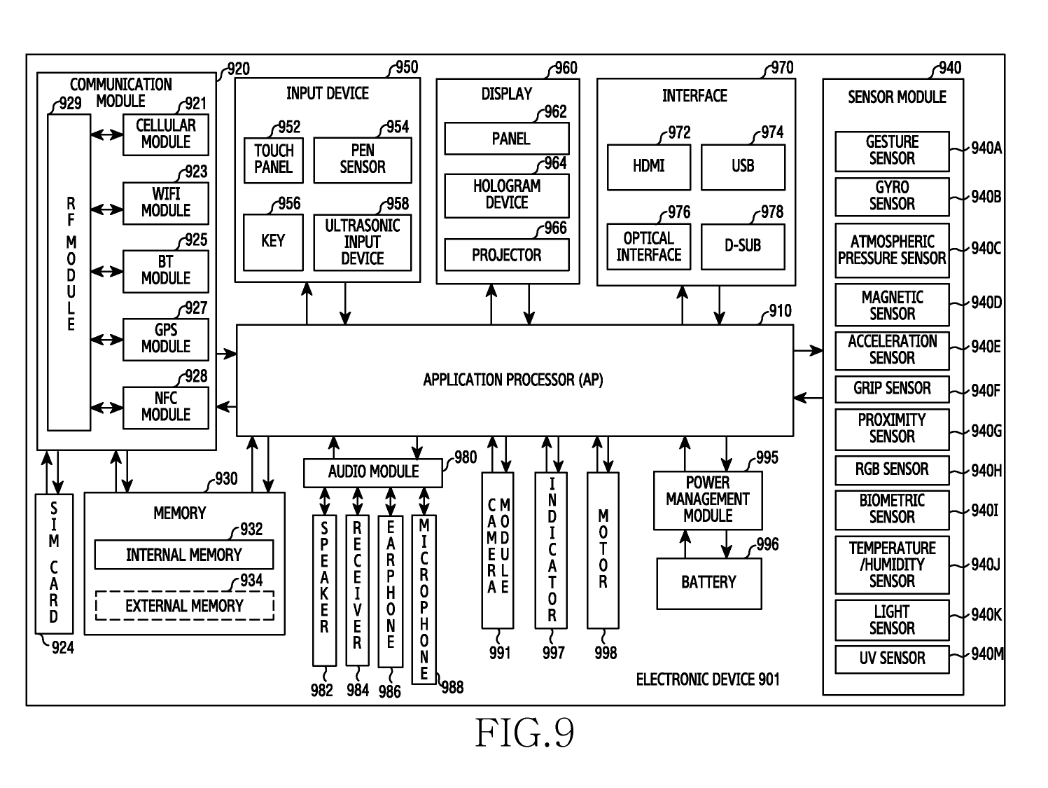

FIG. 9 is a diagram illustrating an electronic device 901, according to an embodiment of the present disclosure. The electronic device 901 may include all or some of the components of the electronic device 301 illustrated in FIG. 3.

Referring to FIG. 9, the electronic device 901 may include one or more application processors (AP) 910, a communication module 920, a subscriber identification module (SIM) card 924, a memory 930, a sensor module 940, an input unit 950, a display 960, an interface 970, an audio module 980, a camera module 991, a power management module 995, a battery 996, an indicator 997, or a motor 998.

The AP 910 drives an operating system (OS) or an application to control a plurality of hardware or software elements connected to the AP 910 and performs various data processes including multimedia data and operations. The AP 910 may be implemented, for example, as a System on Chip (SoC). The AP 910 may further include a Graphic Processing Unit (GPU).

The communication module 920 (e.g., the communication interface 380) may transmit and receive data in the communication between the electronic device 901 (e.g., the electronic device 301) and other electronic devices (e.g., the server 201) connected over the network. The communication module 920 may include a cellular module 921, a WiFi module 923, a BT module 925, a GPS module 927, an NFC module 928, and a Radio Frequency (RF) module 929.

The cellular module 921 provides voice communication, image communication, a short message service, or an Internet service, etc. via a communication network (e.g., LTE, LTE-A, CDMA, WCDMA, UMTS, WiBro, or GSM, etc.). Also, the cellular module 921 may perform discrimination and authentication of an electronic device within a communication network using, for example, a Subscriber Identify Module (e.g., a SIM card 924). The cellular module 921 may perform at least a portion of functions that may be provided by the AP 910. For example, the cellular module 921 may perform at least part of a multimedia control function.

The cellular module 921 may include a Communication Processor (CP). The cellular module 921 may be implemented using, for example, a SoC. While the components of the cellular module 921 (e.g., the CP), the memory 930, and the power management module 995 are separated from the AP 910 in FIG. 9, the AP 910 may include at least part (e.g., the cellular module 921) of the above-stated components.

The AP 910 or the cellular module 921 (e.g., the CP) may load and process the instruction or the data received from its connected non-volatile memory or one or more of the other components, in a volatile memory. Also, the AP 910 or the cellular module 921 may store data received from or generated by one or more of the other components, in the non-volatile memory.

Each of the WiFi module 923, the BT module 925, the GPS module 927, or the NFC module 928 may include, for example, a processor for processing data transmitted/received via a relevant module. While the cellular module 921, the WiFi module 923, the BT module 925, the GPS module 927, and the NFC module 928 are separated from each other in FIG. 9, at least part (e.g., at least two) of the cellular module 921, the WiFi module 923, the BT module 925, the GPS module 927, and the NFC module 928 may be included in a single Integrated Chip (IC) or an IC package. For example, at least part (e.g., the CP corresponding to the cellular module 921 and the WiFi processor corresponding to the WiFi module 923) of the processors corresponding to the cellular module 921, the WiFi module 923, the BT module 925, the GPS module 927, and the NFC module 928 may be implemented using a single SoC.

The RF module 929 may transmit and receive the data, for example, RF signals. The RF module 929 may include, for example, a transceiver, a Power Amp Module (PAM), a frequency filter, and a Low Noise Amplifier (LNA), which are not shown. Also, the RF module 929 may further include a component, for example, a conductor or a conducting wire, for sending and receiving electromagnetic waves in free space during the wireless communication. While the cellular module 921, the WiFi module 923, the BT module 925, the GPS module 927, and the NFC module 928 share the single RF module 929 in FIG. 9, one or more of the cellular module 921, the WiFi module 923, the BT module 925, the GPS module 927, and the NFC module 928 may transmit and receive the RF signals via a separate RF module.

The SIM card 924 may be inserted into a slot formed in a specific position of the electronic device 901. The SIM card 924 may include unique identify information (e.g., Integrated Circuit Card Identifier (ICCID)) or subscriber information (e.g., International Mobile Subscriber Identity (IMSI)).

The memory 930 (e.g., the memory 330) includes a built-in memory 932 or an external memory 934. The built-in memory 932 may include, for example, one or more of a volatile memory (e.g., Dynamic RAM (DRAM), Static RAM (SRAM), Synchronous Dynamic RAM (SDRAM)) and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, etc.).

The internal memory 932 may be a Solid State Drive (SSD). The external memory 934 may further include a flash drive, for example, Compact Flash (CF), Secure Digital (SD), Micro Secure Digital (Micro-SD), Mini Secure Digital (Mini-SD), extreme Digital (xD), or a memory stick. The external memory 934 may be functionally connected with the electronic device 901 via various interfaces. The electronic device 901 may further include a storage device (or a storage medium) such as a hard drive.

The sensor module 940 measures a physical quantity or detects an operation state of the electronic device 901 and converts the measured or detected information to an electric signal. The sensor module 940 includes, for example, one or more of a gesture sensor 940A, a gyro sensor 940B, an atmospheric pressure sensor 940C, a magnetic sensor 940D, an acceleration sensor 940E, a grip sensor 940F, a proximity sensor 940G, a color sensor 940H (e.g., red, green, blue (RGB) sensor), a living body sensor 940I, a temperature/humidity sensor 940J, an illumination sensor 940K, or an Ultra Violet (UV) sensor 940M. Additionally or alternatively, the sensor module 940 may include, for example, an E-nose sensor, an electromyography (EMG) sensor, an electroencephalogram (EEG) sensor, an electrocardiogram (ECG) sensor, an infrared (IR) sensor, an iris sensor, or a fingerprint sensor, etc. The sensor module 940 may further include a control circuit for controlling one or more sensor belonging thereto.

The input unit 950 may include a touch panel 952, a (digital) pen sensor 954, a key 956, or an ultrasonic input unit 958. The touch panel 952 recognizes a touch input using one or more of capacitive, resistive, infrared, or ultrasonic methods. Also, the touch panel 952 may further include a control circuit. A capacitive touch panel may perform detection by a physical contact or proximity recognition. The touch panel 952 may further include a tactile layer. In this case, the touch panel 952 may provide a tactile reaction to a user.

The (digital) pen sensor 954 may be implemented using, for example, the same or similar method as or to the user's touch input, or using a separate recognition sheet. For example, the key 956 may include, for example, a physical button, an optical key, or a keypad. The ultrasonic input device 958 is a device capable of obtaining data by detecting microwaves through a microphone (e.g., a microphone 988) in the electronic device 901 through an input tool which generates an ultrasonic signal, allows radio frequency identification. The electronic device 901 may receive user input from an external device (e.g., a server or an Internet of Things (IoT) device) connected using the communication module 920.

The display 960 (e.g., the display 370) includes a panel 962, a hologram device 964, or a projector 966. The panel 962 may be, for example, a Liquid Crystal Display (LCD), or an Active-Matrix Organic Light-Emitting Diode (AM-OLED), etc. The panel 962 may be implemented, for example, such that it is flexible, transparent, or wearable. The panel 962 may be configured as one module together with the touch panel 952. The hologram device 964 may project a three-dimensional image in the air using interferences of light. The projector 966 may project light onto a screen to display an image. The screen may be positioned, for example, inside or outside the electronic device 901. The display 960 may further include a control circuit for controlling the panel 962, the hologram device 964, or the projector 966.

The interface 970 includes, for example, a High-Definition Multimedia Interface (HDMI) 972, a Universal Serial Bus (USB) 974, an optical interface 976, or a D-subminiature (D-sub) 978. The interface 970 may be included, for example, in the communication interface 380 illustrated in FIG. 3. Additionally or alternatively, the interface 970 may include, for example, a Mobile High-definition Link (MHL) interface, a Secure Digital (SD) card/Multi-Media Card (MMC) interface, or an Infrared Data Association (IrDA) standard interface.

The audio module 980 may convert a sound and an electric signal in dual directions. At least a partial element of the audio module 980 may be included, for example, in the I/O interface 360 illustrated in FIG. 3. The audio module 980 processes sound information input or output via, for example, a speaker 982, a receiver 984, an earphone 986, or the microphone 988, etc.

The camera module 991 is a device that may capture a still image and a moving picture. T camera module 991 may include one or more image sensors (e.g., a front sensor or a rear sensor), a lens, an Image Signal Processor (ISP), or a flash (e.g., an LED or xenon lamp).

The power management module 995 may manage power of the electronic device 901. The power management module 995 may include, although not depicted, for example, a Power Management Integrated Circuit (PMIC), a charger Integrated Circuit (IC), or a battery or fuel gauge.

The PMIC may be mounted in, for example, an IC or a SoC conductor. The charging type may be divided to a wired type and a wireless type. The charger IC may charge the battery, and prevent overvoltage or overcurrent flow from the charger. The charger IC may include a charger IC for one or more of the wired charging type or the wireless charging type. The wireless charging type includes, for example, a magnetic resonance type, a magnetic induction type, and a microwave type, and may add an additional circuit for the wireless charging, for example, a circuit such as coil loop, resonance circuit, or rectifier.

The battery gauge may, for example, measure the remaining capacity of the battery 996 and the voltage, the current, or the temperature of the charging. The battery 996 may store or generate electricity, and supply the power to the electronic device 901 using the stored or generated electricity. The battery 996 may include, for example, a rechargeable battery or a solar battery.

The indicator 997 displays a specific state of the electronic device 901 or a portion thereof (e.g., the AP 910), for example, a booting state, a message state, or a charging state, etc. The motor 998 converts an electric signal to mechanical vibration. The electronic device 901 includes a processor (e.g., a GPU) for supporting a mobile TV. The processor for supporting the mobile TV may process media data corresponding to standards, for example, such as Digital Multimedia Broadcasting (DMB), Digital Video Broadcasting (DVB), or a media flow, etc.

Each of the aforementioned constitutional elements of the electronic device according to various exemplary embodiments of the present disclosure may consist of one or more components, and names thereof may vary depending on a type of electronic device. The electronic device according to various exemplary embodiments of the present disclosure may include one or more of the aforementioned constitutional elements. Some of the constitutional elements may be omitted, or additional other constitutional elements may be further included. In addition, some of the constitutional elements of the electronic device according to various exemplary embodiments of the present disclosure may be combined and constructed as one entity, so as to equally perform functions of corresponding constitutional elements before combination.

A terminology “module” used for the present disclosure may mean, for example, a unit including a combination of one or two or more among a hardware, a software, or a firmware. A “module” may be interchangeably used with a terminology such as a unit, a logic, a logical block, a component, or a circuit, etc. A “module” may be a minimum unit of an integrally configured part or a portion thereof. A “module” may be a minimum unit performing one or more functions or a portion thereof. A “module” may be mechanically or electronically implemented. For example, a “module” according to the present disclosure may include one or more of an application-specific integrated circuit (ASIC) chip, a field-programmable gate arrays (FPGAs), or a programmable-logic device which are known, or to be developed in the future, and performing certain operations.

At least part of the device (e.g., the modules or the functions) or the method (e.g., the operations) described in the appended claims and/or the specifications of the present disclosure may be implemented using, for example, instructions stored as the programming module in a non-transitory computer-readable storage medium. For example, when an instruction is executed by one or more processors (e.g., the processor 140), the one or more processors perform the corresponding function. The non-transitory computer-readable storage medium may be, for example, the memory 150. At least part of the programming module may be implemented (e.g., executed) by the processor 140. At least part of the programming module may include, for example, a module, a program, sets of instructions, or a process for performing one or more functions.

The non-transitory computer-readable storage media may include a hard disk, a magnetic media such as a floppy disk and a magnetic tape, Compact Disc Read Only Memory (CD-ROM), optical media such as Digital Versatile Disc (DVD), magneto-optical media such as a floptical disk, and a hardware device specially configured for storing and performing a program instruction (e.g., a programming module) such as Read Only Memory (ROM), Random Access Memory (RAM), a flash memory, etc. Also, the program instruction may include not only a machine language code generated by a compiler but also a high-level language code executable by a computer using an interpreter, etc. The above-described hardware device may be configured to operate as one or more software modules in order to perform an operation of the present disclosure, and vice versa.

A module or programming module according to various exemplary embodiments may include one or more or more of the aforementioned constituent elements, or omit some of the aforementioned constituent elements, or include additional other constituent elements. Operations carried out by the module, the programming module or the other constituent elements according to various exemplary embodiments may be executed in a sequential, parallel, iterative or heuristic method. Also, some operations may be executed in different order or may be omitted, or other operations may be added.

In the storage medium storing the instructions, the instructions, when executed by one or more processor, make the one or more processor conduct one or more operation. The one or more operation may include, in an electronic device, displaying a preview image of content, receiving an input for switching from the displayed preview image to a different preview image, according to the received input, switching from the displayed preview image to a preview image of different content or to a different preview image of the content.

As set forth above, the electronic device receives the input for switching and displaying from the displayed content preview screen to a different preview screen, and switches the current content preview screen to a different preview screen of the same content or to a preview screen of different content according to the received input. Therefore, the electronic device may consecutively display the content preview screens without having to switch the screen.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display;
a communication interface configured to send and receive signals to and from a server; and
a processor configured to display a preview image of content received from the server on the display, and, in response to an input, switch from the displayed preview image to a different preview image of the content or switch from the displayed preview image to a preview image of a different content.

2. The electronic device of claim 1, wherein the processor is configured to determine whether the displayed preview image is a first preview image of preview images of the content when the received input is to switch from the displayed preview image to a previous preview image, and, wherein the processor is configured to switch from the displayed preview image to a last preview image of previous content when the displayed preview image is the first preview image of the preview images of the content.

3. The electronic device of claim 2, wherein the processor is configured to switch from the displayed preview image to the previous preview image of the content when the displayed preview image is not the first preview image of the preview images of the content.

4. The electronic device of claim 1, wherein the processor is configured to determine whether the displayed preview image is a last preview image of preview images of the content when the received input is to switch from the displayed preview image to a next preview image, and wherein the processor is configured to switch from the displayed preview image to a first preview image of next content when the displayed preview image is the last preview image of the preview images of the content.

5. The electronic device of claim 4, wherein the processor is configured to switch from the displayed preview image to the next preview image of the content when the displayed preview image is not the last preview image of the preview images of the content.

6. The electronic device of claim 1, wherein the processor is configured to display a content purchase menu when the preview image of the content is displayed.

7. The electronic device of claim 1, wherein the processor is configured to display a preview image index in part of a screen displaying the preview image of the content, and wherein the preview image index comprises a thumbnail image of a preview image.

8. The electronic device of claim 7, wherein the processor is configured to receive an input for the index and, according to the received input, switch from the displayed preview image to a preview image corresponding to the index.

9. The electronic device of claim 1, wherein the preview image comprises an interaction publication controlled by a received input.

10. The electronic device of claim 1, wherein the processor is configured to display a preview image before displaying content detail information on a screen, when a separate content preview image display menu is selected.

11. An operating method of an electronic device, comprising:
displaying a preview image of content received from a server on a display; and
responsive to an input, switching from the displayed preview image to a different preview image of the content or
switching from the displayed preview image to a preview image of a different content.

12. The operating method of claim 11, wherein the switching from the displayed preview image to the different preview image of the content or to the preview image of the different content comprises:
determining whether the displayed preview image is a first preview image of preview images of the content when the received input is to switch from the displayed preview image to a previous preview image; and
switching from the displayed preview image to a last preview image of previous content when the displayed preview image is the first preview image of the preview images of the content.

13. The operating method of claim 12, further comprising:
switching from the displayed preview image to the previous preview image of the content when the displayed preview image is not the first preview image of the preview images of the content.

14. The operating method of claim 11, wherein the switching from the displayed preview image to the different preview image of the content or to the preview image of the different content comprises:
determining whether the displayed preview image is a last preview image of preview images of the content when the received input is to switch from the displayed preview image to a next preview image; and
switching from the displayed preview image to a first preview image of next content when the displayed preview image is the last preview image of the preview images of the content.

15. The operating method of claim 14, further comprising:
switching from the displayed preview image to the next preview image of the content when the displayed preview image is not the last preview image of the preview images of the content.

16. The operating method of claim 11, further comprising:
displaying a content purchase menu when the preview image of the content is displayed.

17. The operating method of claim 11, further comprising:
displaying a preview image index in part of a screen displaying the preview image of the content wherein the index comprises a thumbnail image of a preview image.

18. The operating method of claim 17, further comprising:
receiving an input for the index; and
switching, according to the received input, from the displayed preview image to a preview image corresponding to the index.

19. The operating method of claim 11, wherein the preview image comprises an interaction publication controlled by a received input.

20. The operating method of claim 11, further comprising:
displaying a preview image before displaying content detail information on a screen when a separate content preview image display menu is selected.
